(19) United States
(12) Patent Application Publication
(10) Pub. No.: US 2014/0240317 A1
(43) Pub. Date: Aug. 28, 2014

(54) DISTANCE DETECTING DEVICE CAPABLE OF INCREASING POWER OF OUTPUT LIGHT AND IMAGE PROCESSING APPARATUS INCLUDING THE SAME

(71) Applicant: LG ELECTRONICS INC., Seoul (KR)

(72) Inventors: Nakhoon GO, Seoul (KR); Sangkeun LEE, Seoul (KR)

(73) Assignee: LG ELECTRONICS INC., Seoul (KR)

(21) Appl. No.: 14/179,047

(22) Filed: Feb. 12, 2014

(30) Foreign Application Priority Data
Feb. 28, 2013 (KR) 10-2013-0022321

(51) Int. Cl. G06T 15/50; G01B 11/14

(52) U.S. Cl. CPC G06T 15/506; G01B 11/14
USPC 345/426; 356/5.1

(57) ABSTRACT

A distance detecting device and an image processing apparatus including the same are disclosed. The distance detecting device includes a light source to output light based on a first electric signal, a scanner to sequentially perform first direction a scanner to perform first direction scanning and second direction scanning to output the output light, a detecting unit to detect light received from an external target corresponding to the output light and to convert the received light into a second electric signal, and a processor to calculate a distance from the external target based on the first electric signal and the second electric signal and to control the light source to vary intensity or level of the output light. Consequently, power of light output to the external target is increased.

### CROSS-REFERENCE TO RELATED APPLICATION

This application claims the priority benefit of Korean Patent Application No. 10-2013-0022321, filed on Feb. 28, 2013 in the Korean Intellectual Property Office, the disclosure of which is incorporated herein by reference.

### BACKGROUND OF THE INVENTION

1. Field of the Invention

The present invention relates to a distance detecting device and an image processing apparatus including the same and, more particularly, to a distance detecting device that is capable of increasing power of light output to an external target and an image processing apparatus including the same.

2. Description of the Related Art

A necessity of measuring the distance from an external target has increased. In particular, a necessity of viewing a three-dimensional (3D) image, i.e. a stereoscopic image, in addition to a two-dimensional (2D) image has increased. The distance from an external target may be detected to detect the depth of a 3D image. Various methods of detecting the distance from an external target have been implemented.

For a distance detecting device using output light for distance detection, on the other hand, the law stipulates that the output light should not be harmful to humans in many countries. In particular, power of the output light is limited to protect human eyes.

### SUMMARY OF THE INVENTION

It is an object of the present invention to provide a distance detecting device that is capable of increasing power of light output to an external target and an image processing apparatus including the same.

In accordance with one aspect of the present invention, the above and other objects can be accomplished by the provision of a distance detecting device including a light source to output light based on a first electric signal, a scanner to perform first direction scanning and second direction scanning to output the output light, a detecting unit to detect light received from an external target corresponding to the output light and to convert the received light into a second electric signal, and a processor to calculate a distance from the external target based on the first electric signal and the second electric signal and to control the light source to vary intensity or level of the output light.

In accordance with another aspect of the present invention, there is provided a distance detecting device including a light source to output light based on a first electric signal, a scanner to perform first direction scanning and second direction scanning to output the output light to a scanning area, a detecting unit to detect light received from an external target corresponding to the output light and to convert the received light into a second electric signal, and a processor to calculate a distance from the external target based on the first electric signal and the second electric signal, wherein the scanner is operated in a first scanning mode to output the output light to the scanning area and a second scanning mode to output the output light to a portion of the scanning area.

In accordance with another aspect of the present invention, there is provided an image processing apparatus including a display unit, a distance detection unit comprising a light source to output light based on a first electric signal, a scanner to perform first direction scanning and second direction scanning to output the output light, a detecting unit to detect light received from an external target corresponding to the output light and to convert the received light from an external target corresponding to the output light into a second electric signal, and a processor to calculate a distance from the external target based on the first electric signal and the second electric signal and to control the light source to vary intensity or level of the output light, and a controller to control the display unit to display a three-dimensional (3D) image using distance information detected by the distance detection unit.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing that light for distance detection is projected from an image processing apparatus including a distance detecting device according to an embodiment of the present invention;

FIG. 2A is a view exemplarily showing a scanning method when light is projected from the distance detecting device of FIG. 1;

FIG. 2B is a view exemplarily showing distance information that can be obtained by the distance detecting device of FIG. 1;

FIG. 3 is a view illustrating a distance detection method of the distance detecting device of FIG. 1;

FIG. 4 is a view showing an example of the internal structure of the distance detecting device of FIG. 1;

FIG. 5 is a view exemplarily showing the distance between the distance detecting device and an external target;

FIG. 6 is an internal block diagram of a distance detecting device according to an embodiment of the present invention;

FIGS. 7 to 14C are views illustrating operation of the distance detecting device according to the embodiment of the present invention;

FIG. 15 is an internal block diagram of a mobile terminal as an example of the image processing apparatus; and

FIG. 16 is an internal block diagram of a controller of FIG. 15.

### DETAILED DESCRIPTION OF THE PREFERRED EMBODIMENTS

Reference will now be made in detail to the preferred embodiments of the present invention, examples of which are illustrated in the accompanying drawings.

An image processing apparatus as described in this specification may be an apparatus in which a distance detecting device may be mounted. The image processing apparatus may include a mobile terminal, a television (TV), a settop box, a media player, a game console, and a monitoring camera. Furthermore, the image processing apparatus may include electric home appliances, such as an air conditioner, a refrigerator, a washing machine, a cooking device, and a robot cleaner. In addition, the image processing apparatus may include vehicles, such as a bicycle and a car.

Meanwhile, the mobile terminal may include a mobile phone, a smartphone, a laptop computer, a digital broadcast terminal, a personal digital assistant (PDA), a portable multimedia player (PMP), a digital camera, a navigation system, a tablet computer, and an electronic book (e-book) terminal.

The terms “module” and “unit,” when attached to the names of components are used herein to aid in understanding of the components and thus they should not be considered as having specific meanings or roles. Accordingly, the terms “module” and “unit” may be used interchangeably.

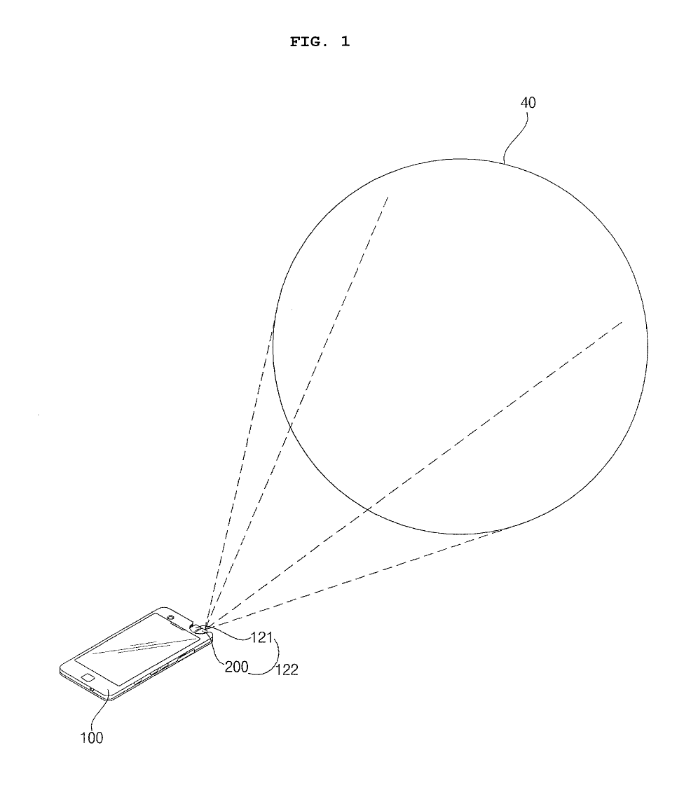

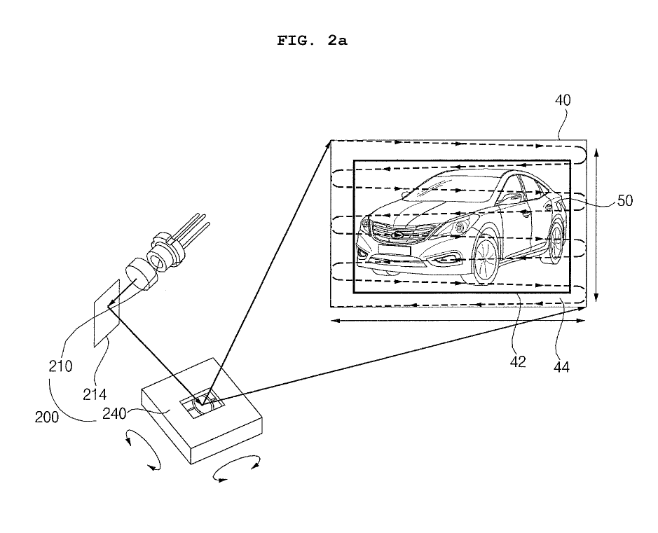

FIG. 1 is a view showing that light for distance detection is projected from an image processing apparatus including a distance detecting device according to an embodiment of the present invention.

Referring to FIG. 1, a mobile terminal 100 is shown as an example of the image processing apparatus. As previously described, a distance detecting device 200 may be mounted in an image processing apparatus, such as a mobile terminal, a TV, a settop box, a media player, a game console, an electric home appliance, and a vehicle. Hereinafter, a description will be given based on the mobile terminal 100.

The mobile terminal 100 may include a camera 121 to capture an image. In addition, the mobile terminal 100 may include a distance detecting device 200 to capture a three-dimensional (3D) image.

The camera 121 to acquire an image of a scanning area and the distance detecting device 200 to acquire information regarding the distance from the scanning area 40 may be provided in a 3D camera 122. The 3D camera 122 may be a single module including the camera 121 and the distance detecting device 200.

Alternatively, the camera 121 and the distance detecting device 200 may be mounted in the mobile terminal 100 as separate modules.

In this embodiment, the distance detecting device 200 outputs light to the scanning area 40 using at least one light source, receives a plurality of received beams scattered or reflected by the scanning area 40, and detects the distance from the scanning area 40 using the difference between the output light and the received beams.

Particularly, in this embodiment, the distance detecting device 200 outputs light such that power of the output light per unit area output to a first area of the scanning area 40 and power of the output light per unit area output to a second area of the scanning area 40 are different from each other to increase power of light output to an external target.

In particular, for edge areas, light is output to one selected from between a first direction scanning section and a second direction scanning section and is not output to the other direction scanning section to increase power of light output to the external target. Furthermore, eyes of a user located in the edge areas may be protected.

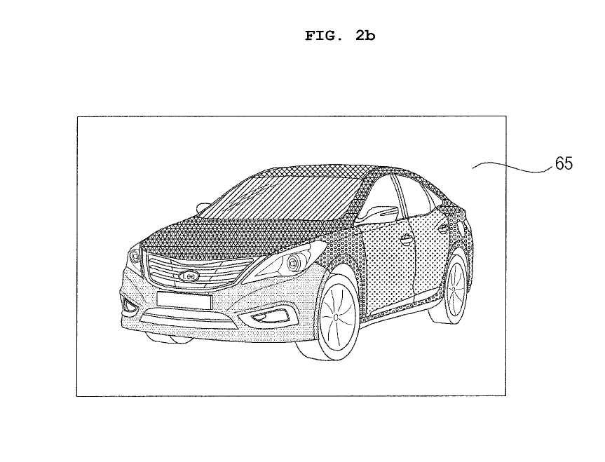

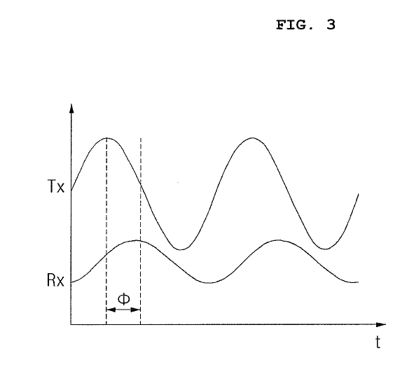

Meanwhile, a two-dimensional (2D) scanner that is capable of sequentially performing first direction scanning and second direction scanning may be used to output light corresponding to the external target. In this case, it is not necessary to use a plurality of scanners, thereby miniaturizing the distance detecting device 200. In addition, it is possible to reduce manufacturing cost of the distance detecting device 200. The scanner will hereinafter be described with reference to FIG. 2A.

FIG. 2A is a view exemplarily showing a scanning method when light is projected from the distance detecting device of FIG. 1.

Referring to FIG. 2A, the distance detecting device 200 may include a light source 210, a light reflection unit 214, and a scanner 240.

The distance detecting device 200 may output light of a single wavelength. Alternatively, the distance detecting device 200 may output light of plural wavelengths. In the following description, the distance detecting device 200 outputs light of a single wavelength.

The light source 210 may output light of a specific wavelength as output light. The output light may be light of an infrared wavelength. However, the present invention is not limited thereto. For example, the light source 210 may output light of a visible wavelength. Hereinafter, a description will be given based on light of an infrared wavelength.

On the other hand, the light source 210 may output light of plural wavelengths.

When light from the light source 210 is projected onto an external target, it is important to collimate the light. To this end, a laser diode may be used. However, the present invention is not limited thereto and various other examples are possible.

Light output from the light source 210 may be reflected by the light reflection unit 214 and incident upon the scanner 240.

Meanwhile, the scanner 240 may receive the light output from the light source 210 and sequentially and repeatedly perform first direction scanning and second direction scanning corresponding to an external target.

As shown in FIG. 2A, the scanner 240 may perform horizontal scanning from left to right, vertical scanning from top to bottom, horizontal scanning from right to left, and vertical scanning from top to bottom corresponding to the scanning area 40 within an area that can be scanned. This scanning operation may be repeatedly performed corresponding to the entirety of the scanning area 40.

Alternatively, the scanner 240 may perform scanning from left to right and scanning from right to left corresponding to the scanning area 40 within an area that can be scanned. This scanning operation may be repeatedly performed corresponding to the entirety of the scanning area 40.

Meanwhile, the light output to the scanning area 40 may be scattered or reflected by the scanning area 40 and incident upon the distance detecting device 200. For example, the scanner 240 may receive light corresponding to the light output to the external target.

The distance detecting device 200 may detect the distance from an external target based on the difference between the output light and the received light. Various distance detection methods may be used. In this embodiment, a distance detection method using phase difference is used, which will hereinafter be described with reference to FIG. 3.

Meanwhile, distance information calculated by the distance detecting device 200 may be expressed as a brightness image 65 as shown in FIG. 2B. Various distance values from the external target may be indicated as corresponding brightness levels. In case of a short distance, a brightness level may be high (bright). In case of a long depth, a brightness level may be low (dark).

In this embodiment, on the other hand, the distance detecting device 200 outputs light using a plurality of transmission signals having different frequencies. The distance detecting device 200 receives light corresponding to the output light and converts the received light into a plurality of reception signals. The distance detecting device 200 measures the distance from the external target based on the transmission signals and the reception signals.

Meanwhile, as shown in FIG. 2A, the scanning area 40 may be divided into a first area 42 and a second area 44. The first area 42 may be an area which contains an external target 50, i.e. an active area 42. The second area 44 may be an area which does not contain the external target 50, i.e. a blank area 44.

Consequently, an entire scanning section may be divided into a first scanning section corresponding to the area which contains an external target 50, i.e. the active area 42, and a second scanning section corresponding to the area which does not contain the external target 50, i.e. the blank area 44.

FIG. 3 is a view exemplarily showing a distance detection method using phase difference according to an embodiment of the present invention. In FIG. 3, Tx indicates a phase signal of output light and Rx indicates a phase signal of received light.

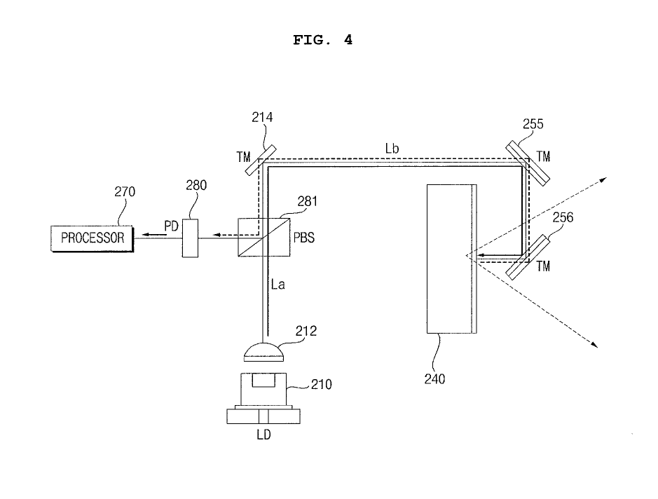

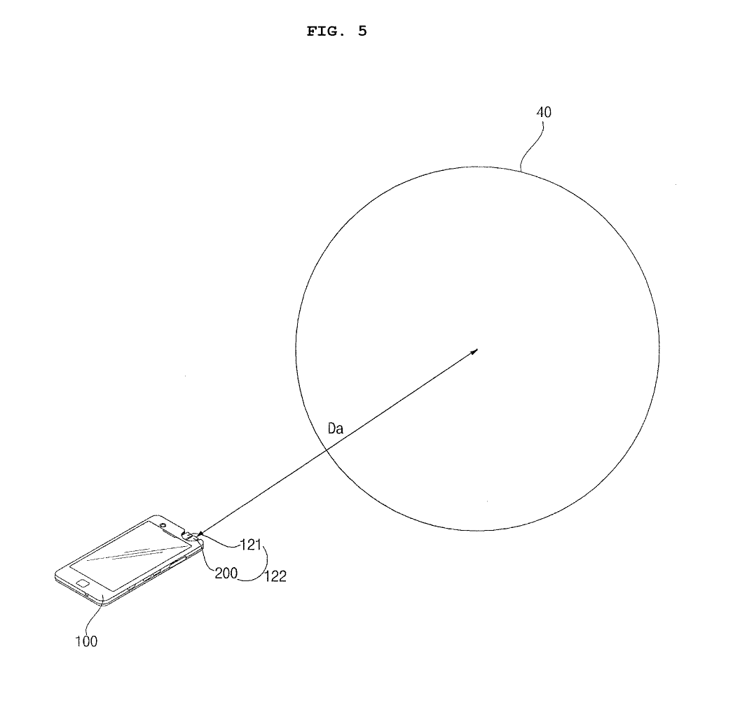

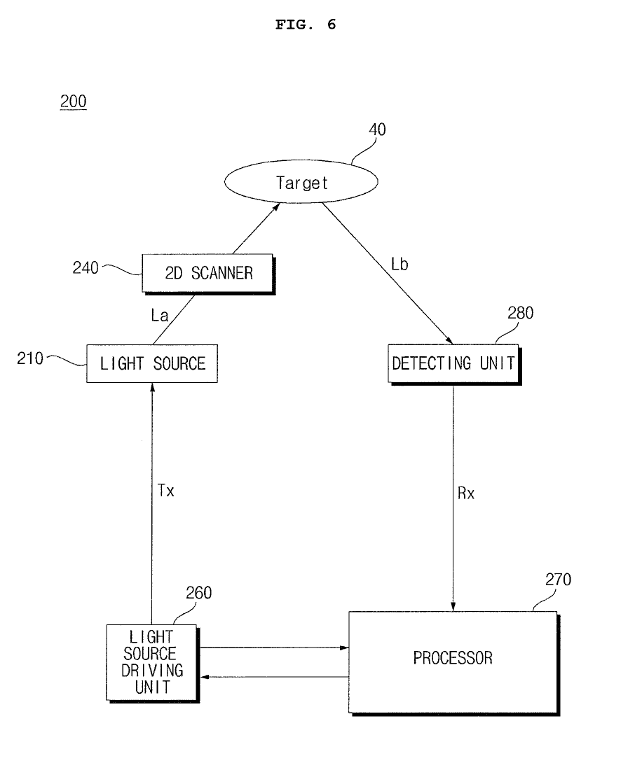

Referring to FIG. 3, a processor 270 (see FIG. 4) of the distance detecting device may calculate a distance information level based on a phase difference Φ between a phase signal of output light and a phase signal of received light.

For example, when the phase difference is large, which means that the scanning area 40 is distant, the distance information level may be set to high. On the other hand, when the phase difference is small, which means that the scanning area 40 is near, the distance information level may be set to low.

As previously described, the scanning area may be horizontally and vertically scanned to set the distance information level per area of the scanning area 40. Meanwhile, the distance information level may be detected per area of the scanning area 40.

Meanwhile, the processor 270 (see FIG. 4) of the distance detecting device may calculate a distance information level based on a phase difference between an electric signal of output light and an electric signal of received light.

FIG. 4 is a view showing an example of the internal structure of the distance detecting device of FIG. 1.

Referring to FIG. 4, the distance detecting device 200 may include a light source 210, a condensing unit 212, a first light reflection unit 214, a scanner 240, a second light reflection unit 255, a third light reflection unit 256, a detecting unit 280, a polarized beam splitting unit 281, and a processor 270.

The condensing unit 212 collimates light La output from the light source 210. To this end, the condensing unit 212 may include a collimate lens to collimate the output light. At this time, the output light may be light having two transmission signals La and Lb added thereto, i.e. modulated light.

The output light La, having passed through the condensing unit 212, passes through the polarized beam splitting unit 281.

The polarized beam splitting unit 281 transmits a polarized component of the output light La and reflects a polarized component of the output light La. For example, the first polarized beam splitting unit 281 transmits a P polarized component of the output light such that the P polarized component of the output light is directed to the scanner 240. On the other hand, the first polarized beam splitting unit 281 reflects an S polarized component of the received light such that the S polarized component of the received light is directed to the detecting unit 280. This polarized beam splitting unit may be called a polarized beam splitter (PBS).

The first light reflection unit 214 reflects the output light La having passed through the polarized beam splitting unit 281 to the scanner 240 and reflects the received light received through the scanner 240 to the first polarized beam splitting unit 281. The first light reflection unit 214 may reflect light of different wavelengths in addition to the output light. To this end, the first light reflection unit 214 may include a total mirror (TM).

Meanwhile, although not shown, a polarized beam conversion unit (not shown) may be provided between the first light reflection unit 214 and the second light reflection unit 255.

The polarized beam conversion unit (not shown) may convert a polarization direction of the output light and a polarization direction of the received light.

For example, the polarized beam conversion unit (not shown) may provide a phase difference to control the polarization direction. In particular, the polarized beam conversion unit may convert a linearly polarized beam into a circularly polarized beam or a circularly polarized beam into a linearly polarized beam.

Specifically, the polarized beam conversion unit (not shown) converts a P polarized beam of the output light into a circularly polarized beam of the output light. Consequently, the scanner 240 may output the circularly polarized beam of the output light to an external target and receive light Lb corresponding to the circularly polarized beam from the external target. On the other hand, the polarized beam conversion unit (not shown) may convert a circularly polarized beam of the light received through the scanner 240 into an S polarized beam. For this reason, the polarized beam conversion unit (not shown) may be called a quarter wavelength plate (QWP).

In another example, the polarized beam conversion unit (not shown) may output the P polarized beam of the output light without conversion and convert a P polarized beam of the light received from the scanner 240 into an S polarized beam.

The second light reflection unit 255 reflects the output light La from the first light reflection unit 214 to the scanner 240 and reflects the light Lb received through the scanner 240 to the first light reflection unit 214. The second light reflection unit 255 may reflect light of different wavelengths in addition to the output light. To this end, the second light reflection unit 255 may include a total mirror (TM).

The third light reflection unit 256 reflects the output light having passed through the second light reflection unit 255 to the scanner 240 and reflects the light received through the scanner 240 to the second light reflection unit 255. The third light reflection unit 256 may reflect light of different wavelengths in addition to the output light. To this end, the third light reflection unit 256 may include a total mirror (TM).

Meanwhile, in the distance detecting device of FIG. 4, an optical path of the output light La and an optical path of the received light Lb may partially overlap. A distance detecting device configured to have a structure in which an optical path of output light and an optical path of received light partially overlap may be called a coaxial optical system. This distance detecting device may have a compact size, may be resistant to external light, and may exhibit a high signal to noise ratio.

On the other hand, the optical path of the output light and the optical path of the received light may be completely separated from each other. A distance detecting device configured to have a structure in which an optical path of output light and an optical path of received light are completely separated from each other may be called a separated optical system.

Meanwhile, the scanner 240 may receive the output light from the light source 210 and sequentially and repeatedly perform first direction scanning and second direction scanning corresponding to the external target. This scanning operation is repeatedly performed over the entire scanning area 40.

During scanning of the scanner 240, the detecting unit 280 detects light received from an external target corresponding to the output light and converts the output light from the light source 210 into a first electric signal in the first scanning section of the scanning area corresponding to the first area 42 and converts the light received from the external target, which corresponds to the output light, into a second electric signal in the second scanning section of the scanning area 40 corresponding to the second area 44.

To this end, the detecting unit 280 may include a photodiode to convert an optical signal into a reception signal, i.e. an electric signal. In particular, the detecting unit 280 may include a photodiode exhibiting a high photoelectric efficiency, such as an Avalanche photodiode to convert weak light scattered by the external target 50 and received from the external target 50 into an electric signal.

Meanwhile, although not shown, a sampler (not shown) to convert an analog signal into a digital signal may be further provided between the detecting unit 280 and the processor 270.

The sampler (not shown) may sample a first or second reception signal from the detecting unit 280 and output the sampled first or second reception signal.

The processor 270 detects a first distance from the external target 50 using a phase difference between a first transmission signal and a first reception signal having a first frequency. In addition, the processor 270 detects a second distance from the external target 50 using a phase difference between a second transmission signal and a second reception signal having a second frequency. The processor 270 may calculate a final distance from the external target 50 using the first distance and the second distance.

Meanwhile, the processor 270 may control overall operation of the distance detecting device.

FIG. 5 is a view exemplarily showing the distance between the distance detecting device and the external target.

Referring to FIG. 5, the distance between the mobile terminal 100 including the distance detecting device 200 and the scanning area 40 is Da.

FIG. 6 is an internal block diagram of a distance detecting device 200 according to an embodiment of the present invention.

Referring to FIG. 6, the distance detecting device 200 includes a light source 210, a light source driving unit 260, a 2D scanner 240, a first detecting unit 280, and a processor 270.

The light source driving unit 260 outputs a sine wave driving signal Tx of a predetermined frequency to the light source 210.

The light source 210 outputs light La of a single wavelength based on the sine wave driving signal, i.e. a transmission signal Tx.

Meanwhile, the processor 270 may control the light source driving unit 260 to output a transmission signal of a predetermined frequency.

The 2D scanner 240 may perform horizontal scanning from left to right, vertical scanning from top to bottom, horizontal scanning from right to left, and vertical scanning from top to bottom corresponding to a scanning area 40 within an area that can be scanned. This scanning operation may be repeatedly performed corresponding to the entirety of the scanning area 40.

Alternatively, the 2D scanner 240 may perform scanning from left to right and scanning from right to left corresponding to the scanning area 40 within an area that can be scanned. This scanning operation may be repeatedly performed corresponding to the entirety of the scanning area 40. Hereinafter, a description will be given based on an operation of sequentially and repeatedly performing scanning from left to right and scanning from right to left.

Meanwhile, the 2D scanner 240 may output light La of a single wavelength to an external target 50 while sequentially performing scanning from left to right and scanning from right to left.

The light La output to the external target 50 is scattered or reflected by the external target 50. As a result, the distance detecting device 200 may receive light Lb scattered or reflected by the external target 50.

The detecting unit 280 receives the light Lb and converts the received light Lb into a reception signal, i.e. an electric signal. Meanwhile, the transmission signal Tx of the predetermined frequency is added to the output light La. Consequently, the detecting unit 280 may separate a reception signal Rx of a predetermined frequency from the received light.

The separated reception signal Rx is transmitted to the processor 270. The processor 270 may calculate the distance from the external target based on the transmission signal Tx and the reception signal Rx corresponding to the transmission signal Tx.

Meanwhile, in this embodiment, the distance detecting device 200 uses a phase difference method. That is, the distance detecting device 200 may calculate the distance from the external target based on a phase difference between the transmission signal related to the output light and the reception signal related to the received light.

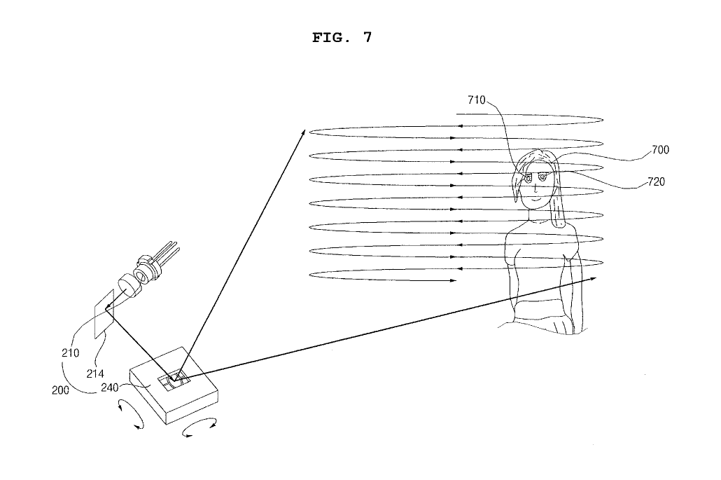

FIGS. 7 to 14C are views illustrating operation of the distance detecting device according to the embodiment of the present invention.

First, FIG. 7 is a view exemplarily showing that the distance detecting device 200 according to the embodiment of the present invention outputs light to an external target in a scanning fashion.

That is, the distance detecting device 200 outputs light output from the light source 210 to the external target through scanning from left to right and scanning from right to left using the 2D scanner 240 and receives light reflected or scattered from the external target.

In a case in which a person 700 is present in a scanning area, the output light may be incident upon two eyes 710 and 720 of the person 700.

In a case in which a laser diode is used as the light source 210 in order to collimate light, however, eyesight of the person 700 may be reduced. For this reason, power of the output light is limited to protect the eyes of the person 700. For example, output power of the distance detecting device 200 may be limited to about 10 to 15 mW.

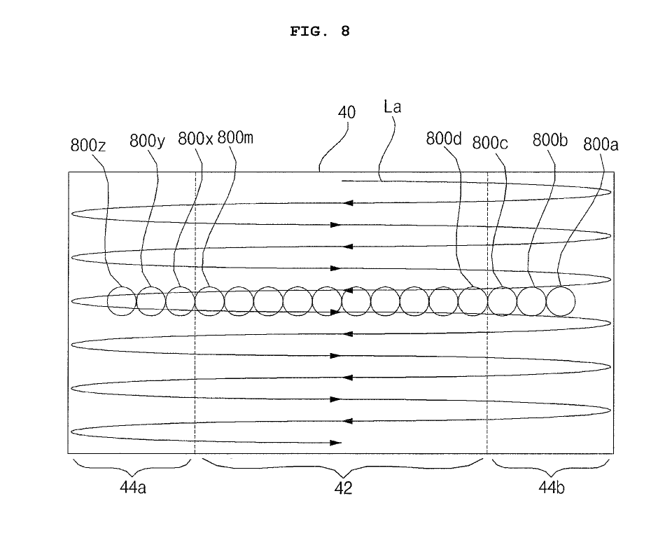

FIG. 8 is a view exemplarily showing various examples of eye positions of users in a scanning area in a case in which the 2D scanner outputs light in a scanning fashion.

As previously described with reference to FIG. 2A, the scanning area 40 is divided into the active area 42 and the blank area 44. Referring to FIG. 8, on the other hand, the scanning area 40 is divided into a main area 42 and edge areas 44a and 44b. The main area 42 and the edge areas 44a and 44b of FIG. 8 may correspond to the active area 42 and the blank area 44 of FIG. 2A, respectively.

FIG. 8 is a view exemplarily showing that light La of uniform power is output to the main area 42 and the edge areas 44a and 44b of the scanning area. In FIG. 8, it is assumed that pupils 800a, 800b, 800c, 800d . . . 800m, 800x, 800y, and 800z of users are arranged in a line. The pupils 800x, 800y, and 800z may be disposed in the first edge area 44a, the pupils 800d . . . 800m may be disposed in the main area 42, and the pupils 800a, 800b, and 800c may be disposed in the second edge area 44b.

In a case in which the 2D scanner 240 of the distance detecting device 200 repeatedly scans the output light from right to left and from left to right, the amount of the output light incident upon the pupils 800a, 800b, 800c, 800x, 800y, and 800z of the users located in the first edge area 44a and the second edge area 44b per unit time is greater than that of the output light incident upon the pupils 800d . . . 800m of the users located in the main area 42 per unit time.

Meanwhile, emission limit is set based on the amount of output light incident per unit time. When output light is output in a scanning fashion, first direction scanning and second direction scanning completion time in the edge areas 44a and 44b is shorter than first direction scanning and second direction scanning completion time in the main area 42. For this reason, emission limit comes into question in the edge areas 44a and 44b rather than in the main area 42.

Consequently, power of light output from the distance detecting device 200 is generally set to low. In particular, power of the output light is set based on the edge areas 44a and 44b. When detecting the distance from the main area in which an external target is actually located, therefore, a signal to noise ratio is lowered and a measurable distance is limited.

In this embodiment, the processor 270 may control the light source 210 through the light source driving unit 260 to vary intensity or level of the output light in the scanning area.

The processor 270 may control the light source 210 such that intensity or level of the output light corresponding to an edge area of the scanning area is less than intensity or level of the output light corresponding to a remaining area of the scanning area except the edge area.

Specially, the processor 270 may control the light source 210 such that power of output light per unit area output to the edge areas of the scanning area and power of output light per unit area output to the main area of the scanning area are different from each other in order to solve the above problems.

More specifically, the distance detecting device 200 may output light in an interlaced fashion. As a result, it is possible to increase power of the output light such that the power of the output light is higher than that of FIG. 8, to improve a signal to noise ratio, to increase a measurable distance, and to improve distance resolution.

Light may be output in various interlaced fashions.

For example, the distance detecting device 200 may output light to the main area 42 per frame without any change and may output light to the edge areas 44a and 44b per frame in an interlaced fashion.

Specifically, the distance detecting device 200 may output light to edge areas 44a and 44b of a first frame through only one selected from between scanning from left to right and scanning from right to left, e.g. only scanning from left to right, and may output light to edge areas 44a and 44b of a second frame through only the other selected from between scanning from left to right and scanning from right to left, e.g. only scanning from right to left.

More specifically, the distance detecting device 200 may perform scanning from left to right corresponding to a first horizontal line of a scanning area of a first frame and scanning from right to left corresponding to a second horizontal line adjacent to the first horizontal line. At this time, light may not be output to a left to right scanning section of the first horizontal line corresponding to the first edge area 44a whereas light may be output to a left to right scanning section of the first horizontal line corresponding to the second edge area 44b. Similarly, light may not be output to a right to left scanning section of the second horizontal line corresponding to the second edge area 44b whereas light may be output to a right to left scanning section of the second horizontal line corresponding to the first edge area 44a.

For the second frame, on the other hand, scanning may be performed in a scanning fashion opposite to that of the first frame. That is, light may not be output to a section of the second frame corresponding to the section of the first frame to which light is output and light may be output to a section of the second frame corresponding to the section of the first frame to which light is not output.

Conversely, the distance detecting device 200 may output light to the edge areas 44a and 44b of the first frame through only one selected from between scanning from left to right and scanning from right to left, e.g. only scanning from right to left, and may output light to the edge areas 44a and 44b of the second frame through only the other selected from between scanning from left to right and scanning from right to left, e.g. only scanning from left to right.

More specifically, the distance detecting device 200 may perform scanning from left to right corresponding to the first horizontal line of the scanning area of the first frame and scanning from right to left corresponding to the second horizontal line adjacent to the first horizontal line. At this time, light may be output to the left to right scanning section of the first horizontal line corresponding to the first edge area 44a whereas light may not be output to the left to right scanning section of the first horizontal line corresponding to the second edge area 44b. Similarly, light may be output to the right to left scanning section of the second horizontal line corresponding to the second edge area 44b whereas light may not be output to the right to left scanning section of the second horizontal line corresponding to the first edge area 44a.

For the second frame, on the other hand, scanning may be performed in a scanning fashion opposite to that of the first frame. That is, light may not be output to a section of the second frame corresponding to the section of the first frame to which light is output and light may be output to a section of the second frame corresponding to the section of the first frame to which light is not output.

In this case, the scanner 240 performs left to right scanning and right to left scanning corresponding to the scanning area. However, the light source 210 may output light of first power to the main area 42 of the scanning area. In addition, the light source 210 may output light of first power to one selected from between the left to right scanning section and the right to left scanning section of the edge areas 44a and 44b of the scanning area and may not output light of first power to the other selected from between the left to right scanning section and the right to left scanning section of the edge areas 44a and 44b of the scanning area.

At this time, the processor 270 may synthesize an electric signal Rx based on light Lb received from the edge areas 44a and 44b of the first frame and an electric signal Rx based on light Lb received from the edge areas, 44a and 44b of the second frame to perform a distance detecting calculation corresponding to the edge areas 44a and 44b. That is, the processor 270 may perform the distance detecting calculation every two frames.

On the other hand, scanning is not performed corresponding to the main area 42 in an interlaced fashion. Consequently, the processor 270 may perform the distance detecting calculation every frame.

In another example, the distance detecting device 200 may perform scanning corresponding to the main area 42 in an interlaced fashion in the same manner as the edge areas 44a and 44b, corresponding to which scanning is performed in an interlaced fashion. That is, the distance detecting device 200 may output light to the main area 42 and the edge areas 44a and 44b of the first frame through only one selected from between scanning from left to right and scanning from right to left, e.g. only scanning from left to right, and output light to the main area 42 and the edge areas 44a and 44b of the second frame through only the other selected from between scanning from left to right and scanning from right to left, e.g. only scanning from right to left. At this time, the processor 270 may perform a distance detecting calculation corresponding to the main area 42 and the edge areas 44a and 44b.

Conversely, the distance detecting device 200 may output light to the main area 42 and the edge areas 44a and 44b of the first frame through only one selected from between scanning from left to right and scanning from right to left, e.g. only scanning from right to left, and output light to the main area 42 and the edge areas 44a and 44b of the second frame through only the other selected from between scanning from left to right and scanning from right to left, e.g. only scanning from left to right.

In another example, the distance detecting device 200 may output light of a first power level to one selected from between the left to right scanning section and the right to left scanning section of the edge areas 44a and 44b of the first frame and output light of a second power level different from the first power level to the other selected from between the left to right scanning section and the right to left scanning section of the edge areas 44a and 44b of the first frame. In addition, the distance detecting device 200 may output light of a third power level to a first direction scanning section and a second direction scanning section of the main area 42. The third power level may be equal to or greater than the first power level or the second power level.

Specifically, light of 23.53 mW may be output to the first direction scanning section and the second direction scanning section of the main area 42 and light of 20 mW may be output to the left to right scanning section of the edge areas 44a and 44b of the first frame and to the right to left scanning section of the edge areas 44a and 44b of the second frame whereas light may not be output to the right to left scanning section of the edge areas 44a and 44b of the first frame and to the left to right scanning section of the edge areas 44a and 44b of the second frame.

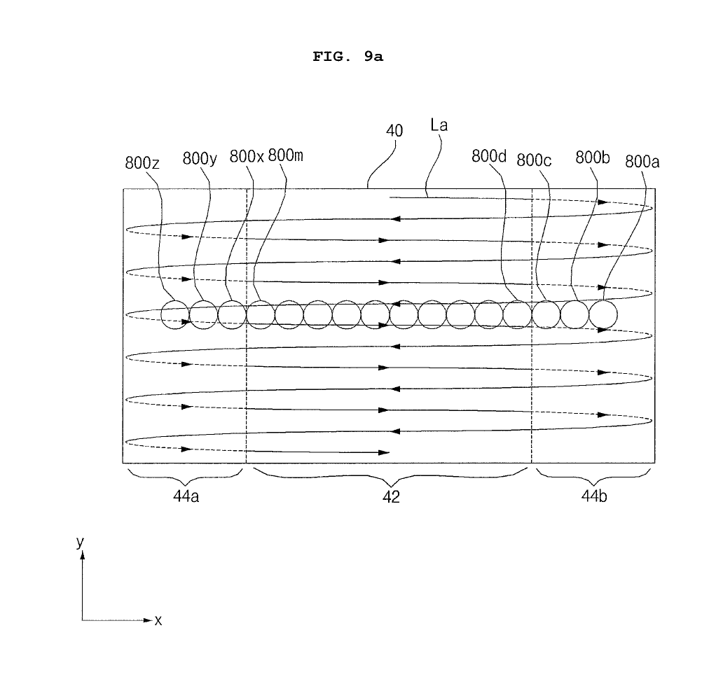

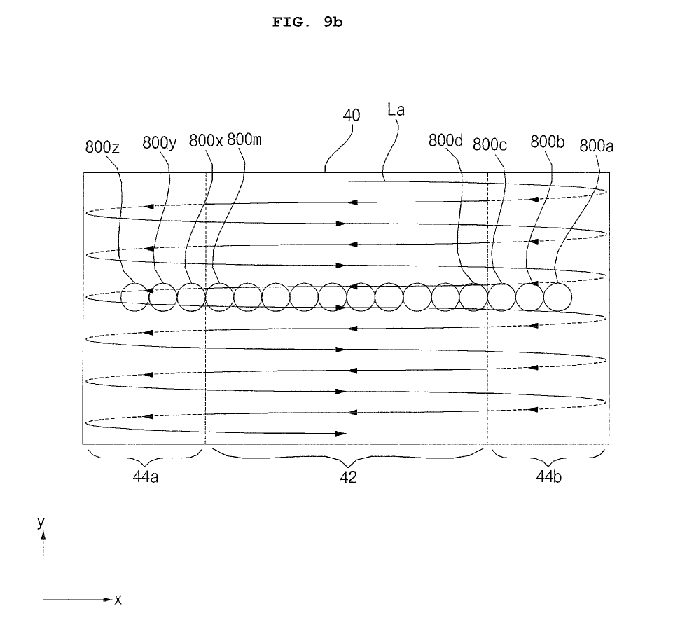

FIG. 9A is a view exemplarily showing a scanning mode performed corresponding to the first frame in the first embodiment of the present invention as described above and FIG. 9B is a view exemplarily showing a scanning mode performed corresponding to the second frame in the first embodiment of the present invention as described above.

Referring to FIG. 9A, the distance detecting device 200 outputs light to the edge areas 44a and 44b of the first frame through only one selected from between scanning from left to right (+x direction scanning) and scanning from right to left (−x direction scanning), e.g. only scanning from left to right (+x direction scanning).

Referring to FIG. 9B, the distance detecting device 200 outputs light to the edge areas 44a and 44b of the first frame through only one selected from between scanning from left to right (+x direction scanning) and scanning from right to left (−x direction scanning), e.g. only scanning from right to left (−x direction scanning).

On the assumption that output lights shown in FIGS. 8, 9A, and 9B have the same power, therefore, the amount of the output light incident upon the pupils 800a, 800b, 800c, 800x, 800y, and 800z of the users located in the first edge area 44a and the second edge area 44b per unit time as shown in FIGS. 9A and 9B is half the amount of the output light incident upon the pupils 800a, 800b, 800c, 800x, 800y, and 800z of the users located in the first edge area 44a and the second edge area 44b per unit time as shown in FIG. 8.

In this interlaced scanning method, on the other hand, the output light may be turned on or off while the scanner performs scanning. The light source 210 may output light to one of the left to right scanning section and the right to left scanning section of the edge areas of the scanning area and may not output light of first power to the other of the left to right scanning section and the right to left scanning section of the edge areas of the scanning area. That is, intensity or level of the output light may be zero in the other of the left to right scanning section and the right to left scanning section of the edge areas of the scanning area. In a case in which the light is output in an interlaced fashion as described above, it is possible to increase life span of the light source 210. Particularly, in a case in which a laser diode is used as the light source 210, it is possible to increase life span of the laser diode, thereby improving device durability.

Meanwhile, in a case in which light is output to the main area 42 without any change whereas light is output to the edge areas 44a and 44b in an interlaced fashion as shown in FIGS. 9A and 9B, an output light off area may be about 23% (6/13×1/2×100) the entire area on the assumption that about 13 pupils of the users are arranged in the scanning area as shown in the drawings.

Meanwhile, Equation 1 below represents international standard regulations for pupil protection prescribing accessible emission limit according to class 1 of IEC 60825-1.

AEL=7×10⁻⁴×t^{0.75}×C6

where AEL indicates accessible emission limit, t indicates total on time pulse, and C6 indicates a variable, which may be decided by Equation 2 below.

$${C}_{6} = 1 for α \leq {α}_{min} \\ {C}_{6} = \frac{α}{{α}_{min}} for {α}_{min} < α \leq {α}_{max} \qquad [ Equation 2 ]$$

where α indicates an angle of light output from the distance detecting device 200 and incident upon a pupil 800 as exemplarily shown in FIG. 100.

In FIG. 8, total accessible power that can be output to the scanning area based on Equation 1 and Equation 2 is 13.99 mW. When light is turned off corresponding to the area corresponding to three pupils in each edge area as shown in FIGS. 9A and 9B, on the other hand, power of the output light may be increased to 23.53 mW. That is, power of FIGS. 9A and 9B is 68% higher than that of FIG. 8.

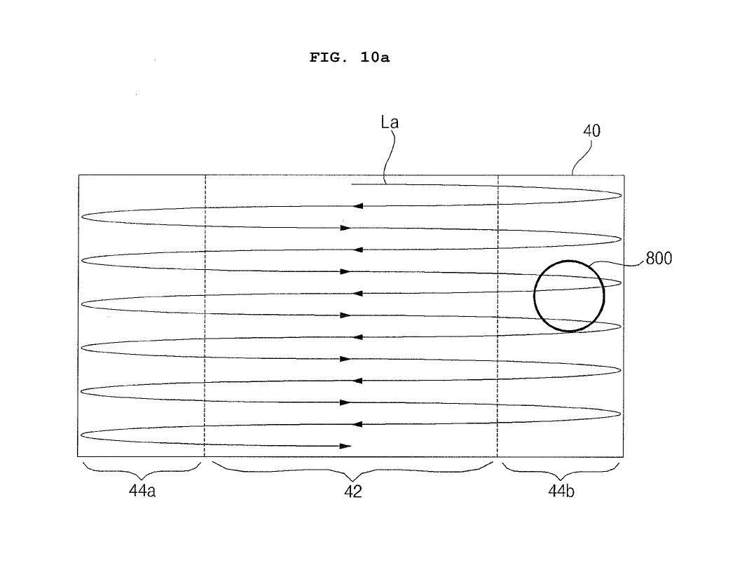

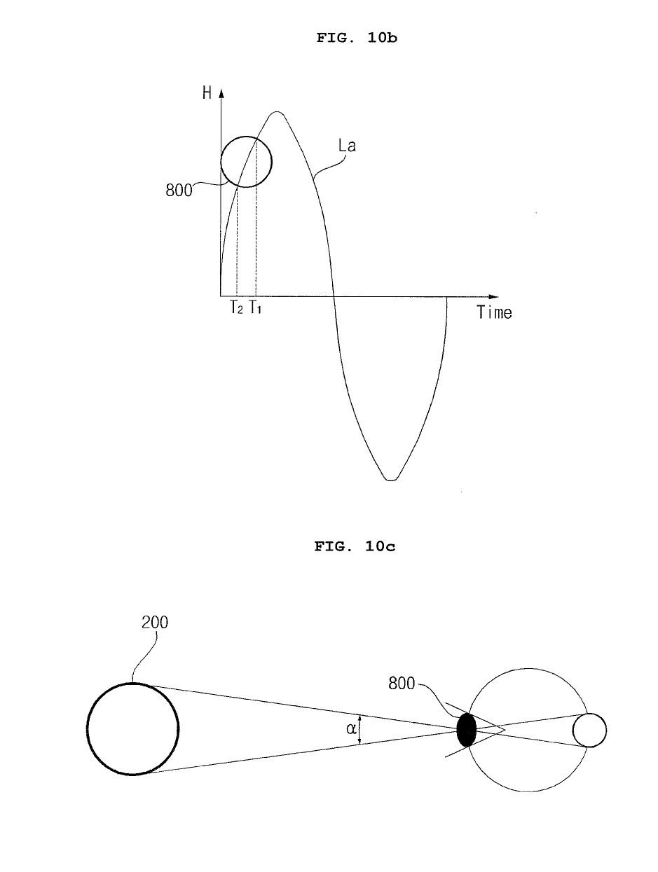

Such a power increase effect will be described in detail with reference to FIGS. 10A and 10B.

As shown in FIG. 10A, scanning is performed twice corresponding to a pupil 800 located in the second edge area 44b within first time T1. FIG. 10B is a view exemplarily showing that output light La is incident upon the pupil 800 at the first time T1 and second time T2. As a result, the number of pulses output from the distance detecting device within the second time T2 is reduced by ½. Consequently, an accessible emission level is lowered according to the above-mentioned regulations of IEC 60825-1.

In a case in which the light source is on for the second time T2 to emit output light, only pulses of the emitted output light are used in summing of energy.

During scanning, on the other hand, Pulse Duration_pa in which light remains in the pupil 800 located in the second edge area 44b is T1−T2, where T1 and T2 may be calculated using Equation 3 below in consideration of scanning based on sine-wave driving in FIGS. 10A and 10B.

$${T}_{1} = \frac{Horizontal Active Pixel}{Horizontal Total Pixel} \times Horizontal Scan Time \times \frac{1}{2} \\ {T}_{2} = \frac{1}{ω} {sin}^{- 1} ( \frac{H sin ( ω {T}_{1} ) - 7}{H} ) \qquad [ Equation 3 ]$$

where Horizontal Active Pixel indicates pixels in one line in the main area 42 and Horizontal Total Pixel indicates all pixels in one line in the scanning area including the main area and the edge areas. In addition, Horizontal Scan Time indicates time necessary to scan one Horizontal total Pixel in a frame and H indicates the size of Horizontal total Pixel.

T1 indicates time necessary to scan half of Horizontal Active Pixel in Horizontal Scan Time and T2 indicates the remaining time of T1 except duration at the pupil 800 in the edge area. FIG. 10B shows at which position of Horizontal Pixel a laser spot is located during Horizontal Scan Time.

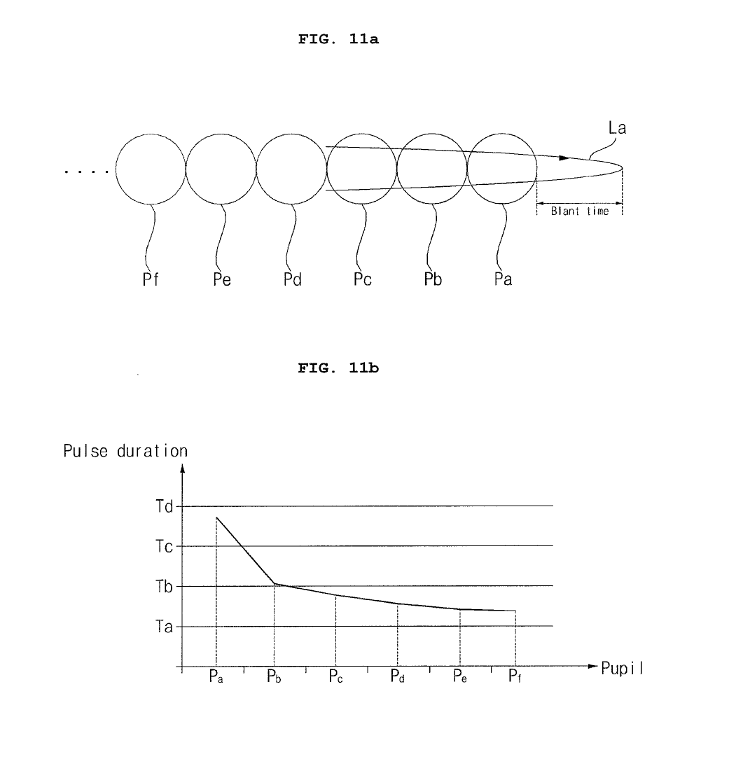

Meanwhile, FIG. 11A shows an arrangement example of pupils during scanning and FIG. 11B is a graph showing pulse duration based on positions of the pupils shown in FIG. 11A.

Pupils Pa, Pb, Pc, Pd . . . of FIG. 11A may correspond to the pupils 800a, 800b, 800c, 800d of FIG. 9A, respectively. The pupil Pa may be disposed at the rightmost area of the scanning area, the pupil Pb may be disposed at the second area from the right of the scanning area, and the pupil Pc may be disposed at the third area from the right of the scanning area.

Pulse duration based on the pupil Pa, the pupil Pb, and the pupil Pc of FIG. 11A may be sequentially calculated as represented by Equation 4 below.

Pulse Duration_{—}p_{—}a=T1−T2,

Pulse Duration_{—}p_{—}b=T2pa−T2_{—}pb,

Pulse Duration_{—}p_{—}c=T2pb−T2_{—}pc [Equation 4]

Where Pulse Duration_pa indicates pulse duration for the pupil Pa of FIG. 11A, Pulse Duration_pb indicates pulse duration for the pupil Pb of FIG. 11A, and Pulse Duration_pc indicates pulse duration for the pupil Pc of FIG. 11A.

It can be seen from FIG. 11B that pulse duration calculated by Equation 4 is increased from the edge areas to the main area. This is because, during scanning of the 2D scanner 240, scanning speed is increased as scanning is performed from the first edge area 44a to the main area 42 and scanning speed is decreased as scanning is performed from the main area 42 to the second edge area 44b.

Meanwhile, the number of pupils upon which interlaced scanning will be performed may be decided in consideration of round pulse duration per pupil.

According to class 1 of IEC 60825-1 as described above, power output to a pupil for reference time Ti must be a predetermined value or less. The reference time Ti is used to determine a single pulse. In a case in which a pulse is shorter than Ti, pulse on time is regarded as Ti.

According to the above regulations, in a case in which a wavelength of output light La is 400 nm to 1050 nm, the reference time Ti corresponds to 1.8×10⁻⁵ sec.

Consequently, it is possible to decide the number of pupils corresponding to which interlaced scanning will be performed in consideration of Round Pulse Duration and scanning time for an area in which scanning is not performed corresponding to an external target within the edge area, i.e. blank time.

Referring to FIG. 11A, the time sum of Round Pulse Duration and blank time of the pupil Pa and Round Pulse Duration and blank time of the pupil Pb corresponds to 1.67×10⁻⁵ sec. In addition, the time sum of Round Pulse Duration and blank time of the pupil Pa, Round Pulse Duration and blank time of the pupil Pb, and Round Pulse Duration and blank time of the pupil Pc corresponds to 1.84×10⁻⁵ sec.

That is, it can be seen that the time sum based on the two pupils Pa and Pb is less than the reference time Ti whereas the time sum based on the three pupils Pa, Pb, and Pc is equal to or greater than the reference time Ti.

As shown in FIG. 11A, therefore, interlaced scanning may be performed corresponding to the edge area 44b corresponding to the three pupils Pa, Pb, and Pc. That is, as shown in FIG. 11A, the light source 210 may be off up to the third pupil Pc from right to left in an interlaced fashion.

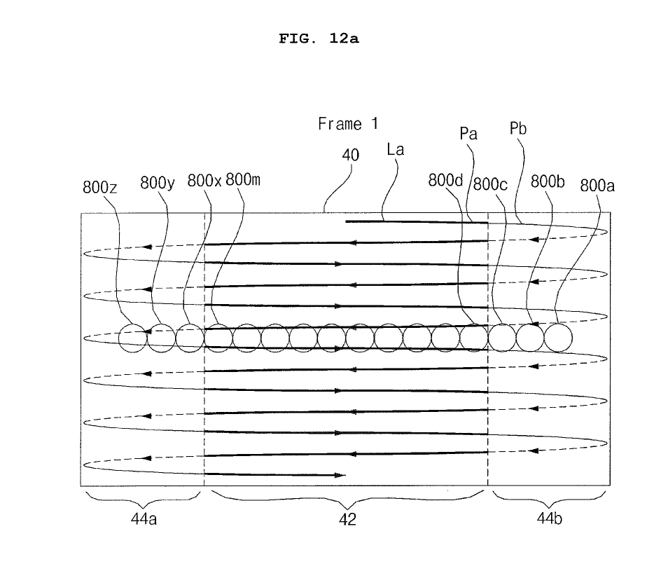

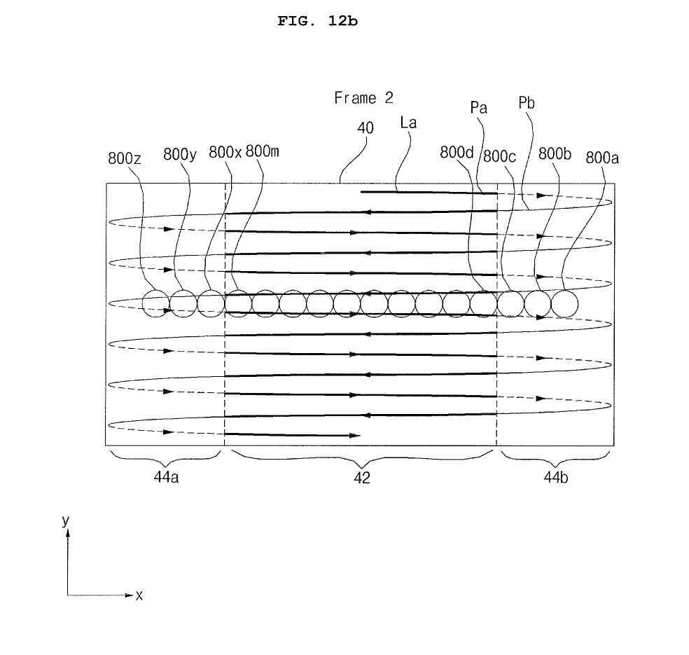

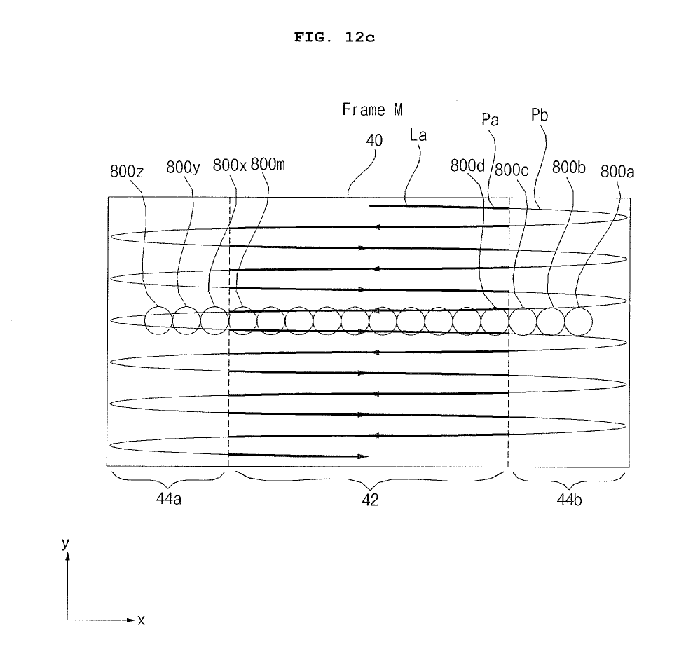

FIGS. 12A to 12C are views exemplarily showing various examples in which power level output to the edge areas and the main area of the scanning area differ.

FIG. 12A is a view exemplarily showing that light of a first power level Pb is output to a left to right scanning section of edge areas 44a and 44b of a first frame (frame 1), no light is output to a right to left scanning section of the edge areas 44a and 44b of the first frame (frame 1), and light of a second power level Pa is output to a main area 42 of the first frame (frame 1). At this time, the first power level Pb may be less than the second power level Pa.

FIG. 12B is a view exemplarily showing that light of a first power level Pb is output to a right to left scanning section of edge areas 44a and 44b of a second frame (frame 2), no light is output to a left to right scanning section of the edge areas 44a and 44b of the second frame (frame 2), and light of a second power level Pa is output to a main area 42 of the second frame (frame 2).

In this case, the processor 270 may perform a distance detecting calculation corresponding to the edge areas 44a and 44b every two frames. On the other hand, the processor 270 may perform the distance detecting calculation every frame.

Since the power level of the light output to the edge areas 44a and 44b is lower than that of the light output to the main area 42 as described above, it is possible to protect the eyes of users located in the edge areas.

FIG. 12C is a view exemplarily showing that light of a first power level Pb is output to a left to right scanning section and a right to left scanning section of edge areas 44a and 44b of a predetermined frame (frame M) and light of a second power level Pa is output to a main area 42 of the predetermined frame (frame M). At this time, the first power level Pb may be less than the second power level Pa.

In this case, the processor 270 may perform a distance detecting calculation corresponding to the edge areas 44a and 44b and the main area 42.

Since the power level of the light output to the edge areas 44a and 44b is lower than that of the light output to the main area 42 as described above, it is possible to protect the eyes of users located in the edge areas.

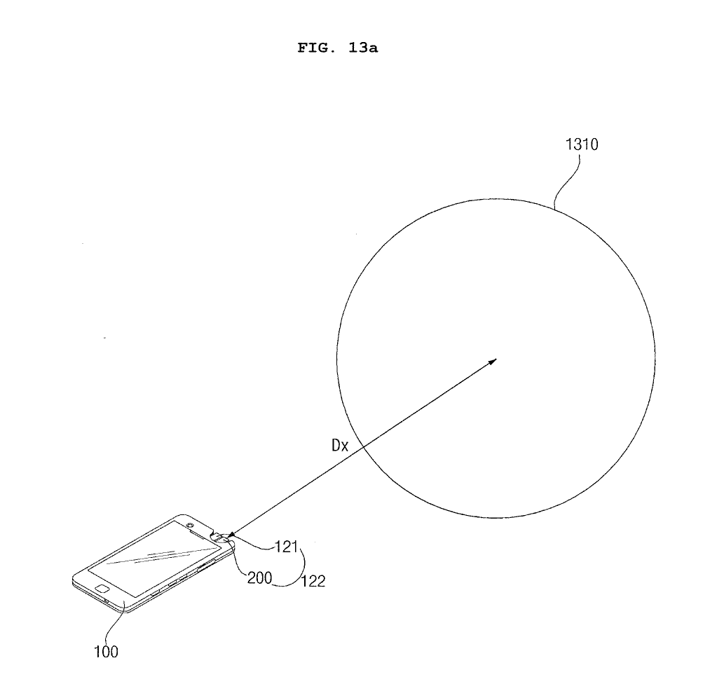

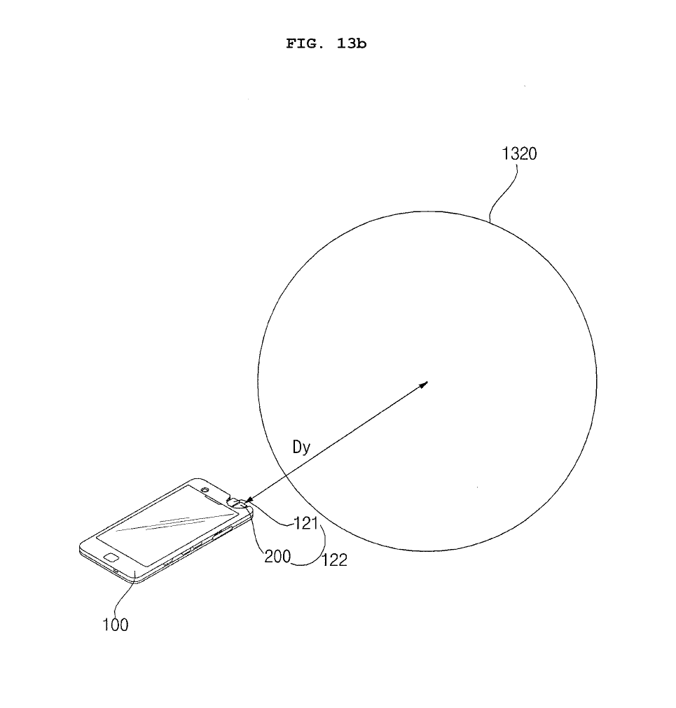

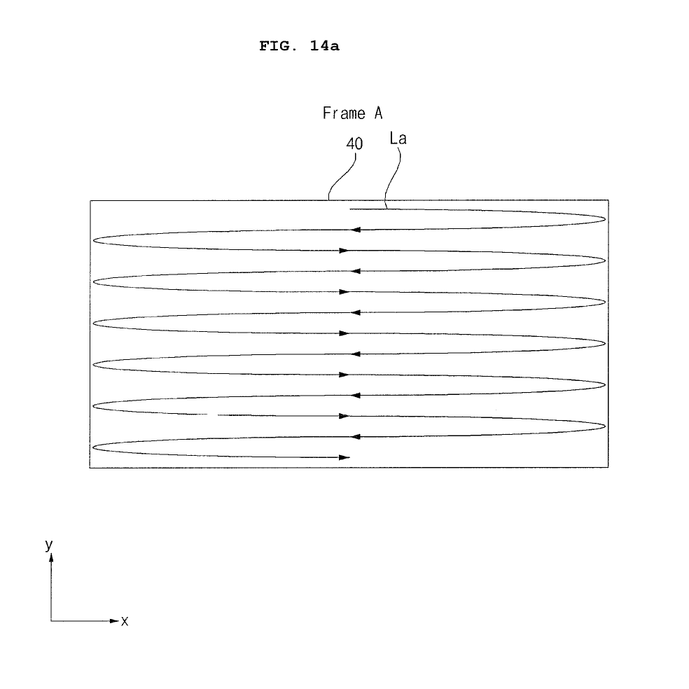

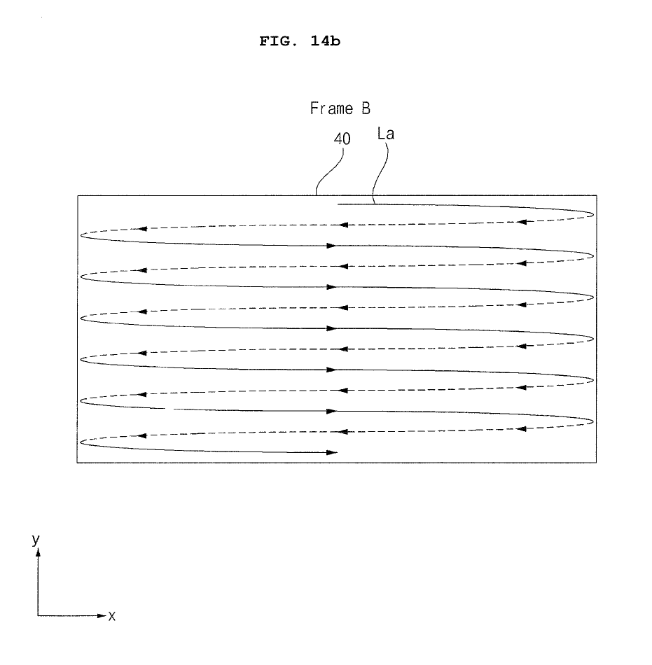

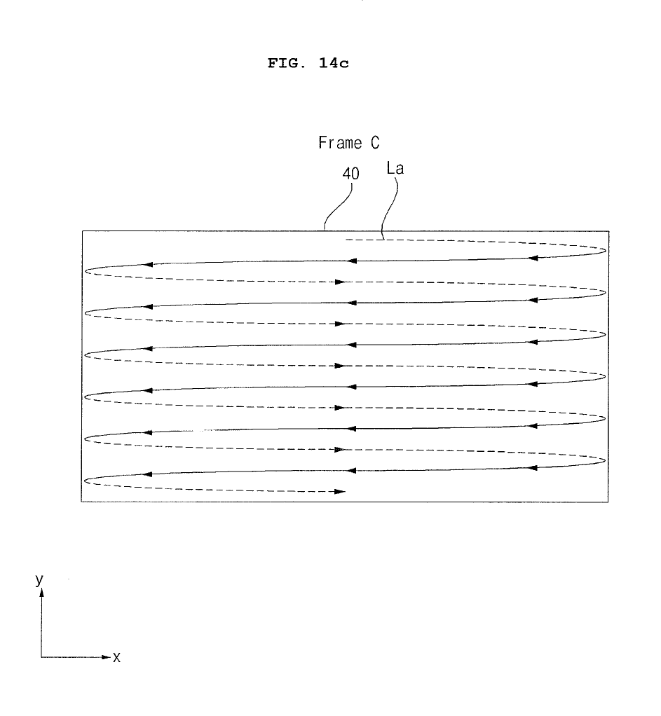

FIGS. 13A to 14C are views exemplarily showing that the distance detecting device performs scanning in different modes depending upon distance.

FIG. 13A shows that the distance between the distance detecting device 200 and an external target 1310 is Da and FIG. 13B shows that the distance between the distance detecting device 200 and an external target 1320 is Db, which is less than Da.

In order to protect the eyes of a user, a power level of output light is changed depending upon the distance between the external target and the distance detecting device 200.

In another embodiment of the present invention, scanning may be performed in a progressive scanning mode or an interlaced scanning mode depending upon the distance between the external target and the distance detecting device 200.

For example, in a case in which the distance between the external target and the distance detecting device 200 is equal to or greater than a predetermined value as shown in FIG. 13A, which means that the external target and the distance detecting device 200 are sufficiently spaced apart from each other, the distance detecting device 200 may be operated in the progressive scanning mode.

FIG. 14A is a view exemplarily showing a progressive scanning mode in which light of a uniform power level is output to the entire scanning area of frame A. In this case, the processor 270 of the distance detecting device 200 may calculate distance information every frame.

In another example, in a case in which the distance between the external target and the distance detecting device 200 is less than the predetermined value as shown in FIG. 13B, which means that the external target and the distance detecting device 200 are near each other, the distance detecting device 200 may be operated in the interlaced scanning mode to protect the eyes of a user.

FIG. 14B is a view exemplarily showing an interlaced scanning mode in which light is output to frame B through scanning from left to right but is not output to frame B through scanning from right to left. On the other hand, FIG. 14C is a view exemplarily showing an interlaced scanning mode in which light is output to frame C through scanning from right to left but is not output to frame C through scanning from left to right. In this case, the processor 270 of the distance detecting device 200 may calculate distance information every two frames.

Meanwhile, the distance between the external target and the distance detecting device 200 may be detected every frame or every plural frames. The processor 270 may output distance information calculated based on the plural frames as final distance information.

In addition, the processor 270 may control the distance detecting device 200 to operate in the progressive scanning mode or in the interlaced scanning mode based on distance information calculated in detection of the distance between the external target and the distance detecting device 200 every frame or every plural frames.

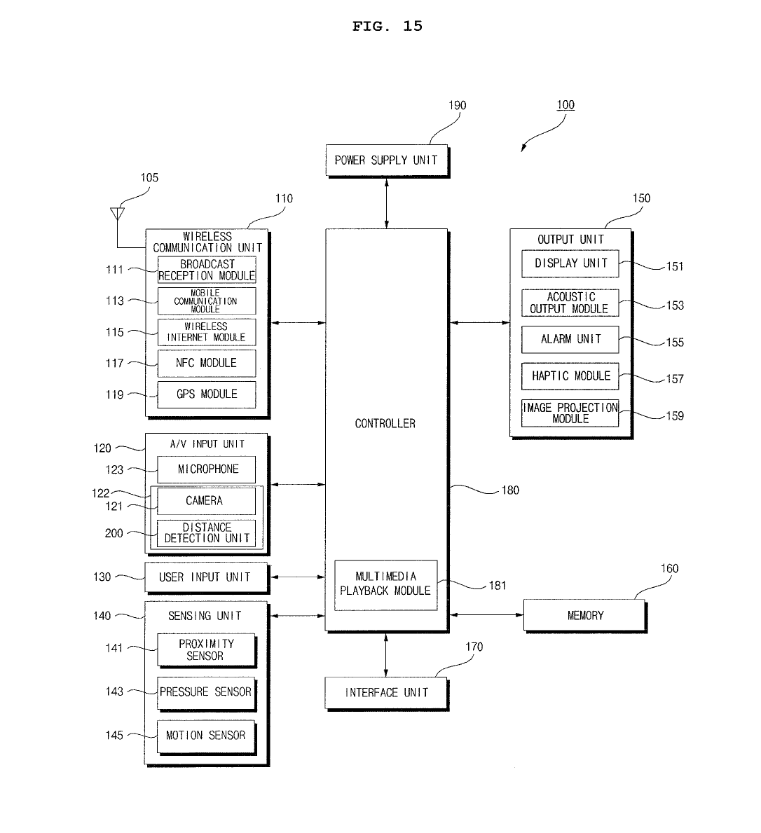

FIG. 15 is an internal block diagram of the mobile terminal of FIG. 1.

Referring to FIG. 15, the mobile terminal 100 may include a wireless communication unit 110, an audio/video (A/V) input unit 120, a user input unit 130, a sensing unit 140, an output unit 150, a memory 160, an interface unit 170, a controller 180, and a power supply unit 190.

The wireless communication unit 110 may include a broadcast receiving module 111, a mobile communication module 113, a wireless Internet module 115, a near field communication (NFC) module 117, and a global positioning system (GPS) module 119.

The broadcast receiving module 111 may receive a broadcast signal and/or broadcast-related information from an external broadcast management server through a broadcast channel. The broadcast channel may include a satellite channel and a terrestrial channel.

The broadcast signal and/or broadcast-related information received through the broadcast receiving module 111 may be stored in the memory 160.

The mobile communication module 113 transmits and receives a wireless signal to and from at least one selected among from a base station, an external terminal, and a server on a mobile communication network. The wireless signal may include a voice call signal, a video communication call signal, and various types of data based on text/multimedia message transmission and reception.

The wireless Internet module 115 is a module for wireless Internet connection. The wireless Internet module 115 may be mounted inside or outside the mobile terminal 100.

The NFC module 117 may perform near field communication. In a case in which the NFC module 117 is within a predetermined distance from an NFC device (not shown), i.e. the NFC module 117 performs tagging, the NFC module 117 may receive data from the NFC device.

The GPS module 119 may receive position information from a plurality of artificial GPS satellites.

The A/V input unit 120 is provided for audio signal or video signal input. The A/V input unit 120 may include a camera 121, a distance detection unit 200, and a microphone 123.

The distance detection unit 200 according to the embodiment of the present invention may be a subminiature type distance detecting device as shown in FIG. 1. The distance detecting device has been already described with reference to FIGS. 2A to 14C and thus a description thereof will be omitted.

Meanwhile, the distance detection unit 200 may be provided in a 3D camera 122 together with the camera 121.

Meanwhile, the calculated distance information may be transmitted to the controller 180 so that calculated distance information is used to display, particularly, a 3D image during reproduction of multimedia or is transmitted to the outside.

The user input unit 130 generates key input data input by a user to control the operation of the terminal. To this end, the user input unit 130 may include a keypad, a dome switch, and a touch pad (static pressure or electrostatic). Particularly in a case in which the touch pad forms a layered structure together with a display unit 151, which will hereinafter be described, an assembly of the touch pad and the display unit 151 may be called a touchscreen.

The sensing unit 140 may sense the present state of the mobile terminal 100, such as an open or closed state of the mobile terminal 100, the position of the mobile terminal 100, and whether user contact has been performed, to generate a sensing signal to control the operation of the mobile terminal 100.

The sensing unit 140 may include a proximity sensor 141, a pressure sensor 143, and a motion sensor 145. The motion sensor 145 may sense the motion or position of the mobile terminal 100 using an acceleration sensor, a gyro sensor, and a gravity sensor. In particular, the gyro sensor is a sensor to measure angular velocity. The gyro sensor may sense a direction (angle) rotated from a reference direction.

The output unit 150 may include a display unit 151, an acoustic output module 153, an alarm unit 155, and a haptic module 157.

The display unit 151 outputs, i.e., displays, information processed by the mobile terminal 100.

Meanwhile, in a case in which the display unit 151 and the touch pad are disposed as a layered structure to form a touchscreen as previously described, the display unit 151 may be used as an input device that allows a user to input information by touch in addition to an output device.

The acoustic output module 153 outputs audio data received from the wireless communication unit 110 or stored in the memory 160. The acoustic output module 153 may include a speaker and a buzzer.

The alarm unit 155 outputs a signal to inform generation of an event of the mobile terminal 100. For example, the alarm unit 155 may output signal in the form of vibration.

The haptic module 157 generates various tactile effects that a user can feel. A typical example of the tactile effects generated by the haptic module 157 is a vibration effect.

The memory 160 may store a program for processing or control of the controller 180 or temporarily store input or output data (for example, phonebooks, messages, still images, moving images, etc.).

The interface unit 170 interfaces between the mobile terminal 100 and all external devices connected to the mobile terminal 100. The interface unit 170 may receive data or power from the external devices and transmit the received data or power to the respective components of the mobile terminal 100. In addition, data from the mobile terminal 100 may be transmitted to the external devices via the interface unit 170.

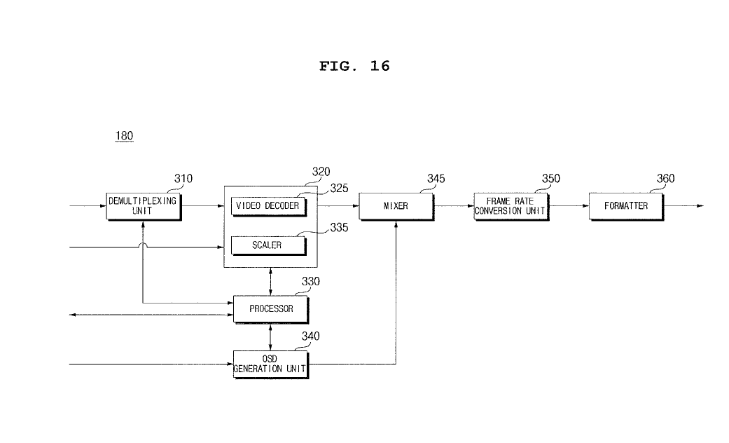

The controller 180 controls operations of the respective components of the mobile terminal 100, thereby controlling overall operation of the mobile terminal 100. For example, the controller 180 may perform control or processing for voice communication, data communication, and video communication. In addition, the controller 180 may include a multimedia reproduction module 181 to reproduce multimedia. The multimedia reproduction module 181 may be incorporated into the controller 180 in the form of hardware. Alternatively, the multimedia reproduction module 181 may be configured in the form of software separately from the controller 180. The operation of the controller 180 for multimedia reproduction will hereinafter be described in detail with reference to FIG. 16.

The power supply unit 190 supplies external power or internal power to the respective components of the mobile terminal 100 under control of the controller 180.

The mobile terminal 100 with the above-stated construction may be configured such that the mobile terminal 100 can be operated in a communication system that is capable of data through frames or packets, including a wired or wireless communication system and a satellite-based communication system.

The block diagram of FIG. 15 shows components constituting the mobile terminal 100 according to the embodiment of the present invention. The respective components in the block diagram may be integrated, added, or omitted according to the specifications of an actually implemented mobile terminal 100. That is, two or more components may be combined into a single unit as needed, or one component may be divided into two or more components as needed. In addition, functions performed by the respective blocks are illustrated to describe the embodiment of the present invention, and therefore, concrete operations or devices of the respective blocks do not restrict the right scope of the present invention.

FIG. 16 is an internal block diagram of a controller of FIG. 15.

Referring to FIG. 16, the controller 180 according to the embodiment of the present invention may include a demultiplexing unit 310, an image processing unit 320, a processor 330, an on screen display (OSD) generation unit 340, a mixer 345, a frame rate converter 350, and a formatter 360 for multimedia reproduction. In addition, the controller 180 may include an audio processing unit (not shown) and a data processing unit (not shown).

The demultiplexing unit 310 demultiplexes an input stream. For example, in a case in which MPEG-2 TS is input, the demultiplexing unit 310 may demultiplex the input MPEG-2 TS into image, voice, and data signals. Here, the stream signal input to the demultiplexing unit 310 may be a stream signal output from the broadcast receiving module 111, the wireless Internet module 115, or the interface unit 170.

The image processing unit 320 may perform image processing corresponding to the demultiplexed image signal. To this end, the image processing unit 320 may include an image decoder 325 and a scaler 335.

The image decoder 325 decodes the demultiplexed image signal. The scaler 335 may scale the resolution of the decoded image signal in consideration of an image output from the display unit 151.

The image decoder 325 may include decoders of different standards.

The processor 330 may control overall operation of the mobile terminal 100 or the controller 180. For example, the processor 330 may control the broadcast receiving module 111 to tune to a radio frequency (RF) broadcast corresponding to a channel selected by a user or a previously stored channel.

In addition, the processor 330 may control the mobile terminal 100 according to user command input through the user input unit 130 or an internal program.

In addition, the processor 330 may control data transmission to a network interface unit 135 or the interface unit 170.

In addition, the processor 330 may control operations of the demultiplexing unit 310, the image processing unit 320, and the OSD generation unit 340 in the controller 180.

The OSD generation unit 340 generates an OSD signal according to user input or even without user input. For example, the OSD generation unit 340 may generate a signal to display various kinds of information in the form of graphs or text in an image output to the display unit 1551 based on a user input signal. The generated OSD signal may include various kinds of data, such as a user interface screen, various menu screens, widgets, and icons. In addition, the generated OSD signal may include 2D objects or 3D objects.

The mixer 345 may mix the OSD signal generated by the OSD generation unit 340 and the image signal decoded through image processing of the image processing unit 320. The mixed image signals are transmitted to the frame rate converter 350.

The frame rate converter (RFC) 350 may convert a frame rate of the input image. On the other hand, the frame rate converter 350 may directly output the input image without frame rate conversion.

The formatter 360 may receive the signals mixed by the mixer 345, i.e. the OSD signal and the decoded image signal, change formats of the signals so that the signals are suitable for the display unit 151, and output the signals, the formats of which have been changed.

In addition, the formatter 360 may divide a 2D image signal and a 3D image signal from each other for 3D image display. In addition, the formatter 360 may change the format of the 3D image signal or convert the 2D image signal into a 3D image signal.

Meanwhile, the formatter 360 may use the distance information calculated by the distance detection unit 200 during 3D image display. Specifically, when the size of a distance information level is large, which means that an external target is distant, the formatter 360 may set a depth information level to low. That is, the formatter 360 may set the depth information level so that the depth information level is inversely proportional to the distance information level. In addition, the formatter 360 may change a 2D image into a 3D image using the depth information and output the 3D image.

When the external target is distant, and the distance information level is high, therefore, the formatter 360 may set the depth information level to low so that the external target is depressed during 3D image display. On the other hand, when the external target is near, and the distance information level is low, therefore, the formatter 360 may set the depth information level to high so that the external target protrudes during 3D image display.

Meanwhile, the audio processing unit (not shown) in the controller 180 may perform voice processing corresponding to the demultiplexed voice signal. To this end, the audio processing unit (not shown) may include various decoders.

In addition, the audio processing unit (not shown) in the controller 180 may adjust bass, treble, and volume.

In FIG. 16, the signals from the OSD generation unit 340 and the image processing unit 320 are mixed by the mixer 345 and are 3D processed by the formatter 360. However, the present invention is not limited thereto. For example, the mixer may be disposed after the formatter. That is, the output of the image processing unit 320 may be 3D processed by the formatter 360, the OSD generation unit 340 may perform 3D processing together with OSD generation, and the respectively processed 3D signals may be mixed by the mixer 345.

The block diagram of FIG. 16 shows components constituting the controller 180 according to the embodiment of the present invention. The respective components in the block diagram may be integrated, added, or omitted according to the specifications of an actually implemented controller 180.

In particular, the frame rate converter 350 and the formatter 360 may not be disposed in the controller 180 but may be separately provided.

Constructions and methods of the embodiments as previously described are not limited to the image processing apparatus including the distance detecting device according to the embodiment of the present invention. All or some of the embodiments may be selectively combined so that the embodiments can be variously modified.

As is apparent from the above description, a distance detecting device according to an embodiment of the present invention or an image processing apparatus including the distance detecting device outputs light such that power of the output light per unit area output to a first area of a scanning area and power of the output light per unit area output to a second area of the scanning area are different from each other, thereby increasing power of light output to an external target.

In particular, for edge areas, light is output to one selected from between a first direction scanning section and a second direction scanning section and is not output to the other direction scanning section, thereby increasing power of light output to the external target. Furthermore, eyes of a user located in the edge areas may be protected. As a result of increasing the power of the power of the light output from the distance detecting device, on the other hand, it is possible to improve a signal to noise ratio and thus to increase a measurable distance. In addition, it is possible to improve distance resolution. Meanwhile, a light source of the distance detecting device outputs light to one selected from between the first direction scanning section and the second direction scanning section and is not output to the other direction scanning section. Consequently, it is possible to increase life span of the light source. Particularly, in a case in which a laser diode is used as the light source, it is possible to increase life span of the laser diode, thereby improving device durability.

In accordance with another embodiment of the present invention, for edge areas, light of a first power level is output to one selected from between a first direction scanning section and a second direction scanning section and light of a second power level is output to the other direction scanning section, thereby protecting eyes of a user in a case in which the eyes of the user are located in the edge areas.

Meanwhile, a 2D scanner that is capable of sequentially performing first direction scanning and second direction scanning may be used to output light to an external target. Consequently, it is not necessary to use a plurality of scanners, thereby miniaturizing the distance detecting device. In addition, it is possible to reduce manufacturing costs of the distance detecting device.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A distance detecting device comprising:
a light source to output light based on a first electric signal;
a scanner to perform first direction scanning and second direction scanning to output the output light;
a detecting unit to detect light received from an external target corresponding to the output light and to convert the received light into a second electric signal; and
a processor to calculate a distance from the external target based on the first electric signal and the second electric signal and to control the light source to vary intensity or level of the output light.

2. The distance detecting device according to claim 1,
wherein the scanner outputs the output light to a scanning area,
wherein the processor controls the light source power such that intensity or level of the output light corresponding to an edge area of the scanning area is less than intensity or level of the output light corresponding to a remaining area of the scanning area except the edge area.

3. The distance detecting device according to claim 2, wherein a sum of power of the output light corresponding to the edge area of the scanning area during the first direction scanning and power of the output light corresponding to the edge area of the scanning area during the second direction scanning is less than a sum of power of the output light corresponding to the remaining area of the scanning area except the edge area during the first direction scanning and power of the output light corresponding to the remaining area of the scanning area except the edge area during the second direction scanning.

4. The distance detecting device according to claim 2, wherein the scanner outputs light of a first power level to one selected from between a first direction scanning section and a second direction scanning section of the edge area of the scanning area and outputs light of a second power level different from the first power level to the other selected from between the first direction scanning section and the second direction scanning section of the edge area of the scanning area.

5. The distance detecting device according to claim 4, wherein
the scanner outputs light of a third power level to the first direction scanning section and the second direction scanning section of a main area of the scanning area except the edge area, and
the third power level is equal to or greater than the first power level or the second power level.

6. The distance detecting device according to claim 2, wherein the scanner outputs the output light to one selected from between a first direction scanning section and a second direction scanning section of the edge area of the scanning area and does not output the output light to the other selected from between the first direction scanning section and the second direction scanning section of the edge area of the scanning area while sequentially performing the first direction scanning and the second direction scanning.

7. The distance detecting device according to claim 2, wherein the scanner outputs:
the output light to one of a first direction scanning section and a second direction scanning section of the edge area of the scanning area during a first frame; and
the output light to the other of the first direction scanning section and the second direction scanning section of the edge area of the scanning area during a second frame following the first frame.

8. The distance detecting device according to claim 6, wherein the scanner outputs the output light to both the first direction scanning section and the second direction scanning section of a main area of the scanning area except the edge area while sequentially performing the first direction scanning and the second direction scanning.

9. The distance detecting device according to claim 7, wherein the processor calculates a distance from the edge area based on a second electric signal based on light received from the first frame and a second electric signal based on light received from the second frame.

10. The distance detecting device according to claim 7, wherein the processor performs:
a distance detecting calculation corresponding to the edge area of the scanning area every two frames; and
a distance detecting calculation corresponding to a main area of the scanning area except the edge area every frame.

11. A distance detecting device comprising:
a light source to output light based on a first electric signal;
a scanner to perform first direction scanning and second direction scanning to output the output light to a scanning area;
a detecting unit to detect light received from an external target corresponding to the output light and to convert the received light into a second electric signal; and
a processor to calculate a distance from the external target based on the first electric signal and the second electric signal, wherein
the scanner is operated in a first scanning mode to output the output light to the scanning area and a second scanning mode to output the output light to a portion of the scanning area.

12. The distance detecting device according to claim 11, wherein
the scanner outputs the output light to a first area of the scanning area of a first frame and outputs the output light to a second area of the scanning area of a second frame following the first frame in the second scanning mode, and
the processor performs a distance detecting calculation corresponding to the first area and the second area every two frames.

13. The distance detecting device according to claim 11, wherein the processor controls the scanner to be operated in one selected from between the first scanning mode and the second scanning mode depending upon the distance from the external target.

14. An image processing apparatus comprising:
a display unit;
a distance detection unit comprising a light source to output light based on a first electric signal, a scanner to perform first direction scanning and second direction scanning to output the output light, a detecting unit to detect light received from an external target corresponding to the output light and to convert the received light from an external target corresponding to the output light into a second electric signal, and a processor to calculate a distance from the external target based on the first electric signal and the second electric signal and to control the light source to vary intensity or level of the output light; and
a controller to control the display unit to display a three-dimensional (3D) image using distance information detected by the distance detection unit.

15. The image processing apparatus according to claim 14, wherein the scanner outputs the output light to a scanning area,
wherein the processor controls the light source power such that intensity or level of the output light corresponding to an edge area of the scanning area is less than intensity or level of the output light corresponding to a remaining area of the scanning area except the edge area.

16. The image processing apparatus according to claim 15, wherein the distance detection unit is configured such that a sum of power of the output light corresponding to the edge area of the scanning area during the first direction scanning and power of the output light corresponding to the edge area of the scanning area during the second direction scanning is less than a sum of power of the output light corresponding to a remaining area of the scanning area except the edge area during the first direction scanning and power of the output light corresponding to the remaining area of the scanning area except the edge area during the second direction scanning.

17. The image processing apparatus according to claim 15, wherein the scanner outputs light of a first power level to one selected from between a first direction scanning section and a second direction scanning section of the edge area of the scanning area and outputs light of a second power level different from the first power level to the other selected from between the first direction scanning section and the second direction scanning section of the edge area of the scanning area.

18. The image processing apparatus according to claim 17, wherein
the light source outputs light of a third power level to the first direction scanning section and the second direction scanning section of a main area of the scanning area except the edge area, and
the third power level is equal to or greater than the first power level or the second power level.

19. The image processing apparatus according to claim 15, wherein the scanner outputs:
the output light to one selected from between a first direction scanning section and a second direction scanning section, e.g. the first direction scanning section, of the edge area of the scanning area of a first frame; and
the output light to the other selected from between the first direction scanning section and the second direction scanning section, e.g. the second direction scanning section, of the edge area of the scanning area of a second frame following the first frame.

20. The image processing apparatus according to claim 18, wherein the scanner outputs the output light to both the first direction scanning section and the second direction scanning section of the main area of the scanning area except the edge area while sequentially performing the first direction scanning and the second direction scanning.
